(19) United States
(12) Patent Application Publication
(10) Pub. No.: US 2006/0122930 A1
(43) Pub. Date: Jun. 8, 2006

(54) Method for maximizing the return on securitized franchise fee cash flow

(76) Inventor: Atit Mahendra Jariwala, New York, NY (US)

Correspondence Address: Anthony Claiborne, 849 136th Ave. N.E., Bellevue, WA, 98005, US

(21) Appl. No.: 11/004,430

(22) Filed: Dec. 3, 2004

(51) Int. Cl. G06Q 40/00

(52) U.S. Cl. 705/38

(57) ABSTRACT

A method for improving the cash flow realized in a franchise business operation comprises securitizing franchise fee cash flow from a group of franchisees and employing the resulting capital for identification and mitigation of risk of default in individual franchisee businesses. The method identifies franchisees at risk of default by creating a predictive data model for default and applying the model to the individual franchisees within the group. Embodiments mitigate risk of default by increasing the franchisee's business volume, by enhancing franchisee human capital, or by increasing the franchisee's business operational efficiency. Some embodiments direct capital to risk mitigation targeted equity investment. The method further provides for optimum timing of risk mitigation efforts.

### BACKGROUND OF THE INVENTION

1. Field of the Invention

This invention relates to methods of utilizing securitization to enhance operations in certain forms of franchise business. More particularly, this invention relates to the use of securitized franchise cash flow assets to identify franchisees at risk of default and further to mitigate default risk among such franchisees, thereby increasing realized cash receipts beyond the predicted risk-discounted value.

2. Description of the Related Art

A franchise business, in its simplest terms, is a license from an owner of a trademark or trade name (the “franchisor”), permitting another (the “franchisee”) to sell a product or service under that name or mark. More broadly stated, a “franchise” has evolved into an elaborate agreement under which the franchisee undertakes to conduct business or sell a product or service in accordance with methods and procedures prescribed by the franchisor, and the franchisor undertakes to assist the franchisee through advertising, promotion and other advisory services. The universal characteristic of a franchise operation is the license grant and business assistance provided by the franchisor to the franchisee combined with the control over the franchise operations that is granted by the franchisee to the franchisor. The success of a franchise business is determined, in part, by the effectiveness of the franchisor's business assistance and control in the franchisee's operations.

“Franchise fees” are consideration paid by the franchisee to the franchisor for the franchise license and the business assistance that the franchisee receives from the franchisor. Franchise fees generally comprise both initial fees for the franchisee to obtain the franchise and commence franchised business operations, as well as recurring fees for maintaining the franchise relationship and carrying on the franchised business operation. The future cash flow that the franchisor expects to receive in the form of recurring fees from franchisees comprises an intangible asset of the franchisor that may be monetized as a risk-discounted present value through securitization.

Any predictable but illiquid cash flow may be monetized by way of securitization. Securitization of cash flows in the United States originated around real estate mortgage payment cash flow in the 1920s, when mortgage insurance companies sold guaranteed mortgage participation certificates for pools of mortgage loans. Investors actively traded these certificates until the real estate market crashed during the Great Depression. Attention was again drawn to securitization of mortgage cash flow in the late 1970s and early 1980s, principally because the economic crisis of that time had greatly reduced the available liquidity of financial institutions to provide mortgage loans.¹ Securitization of mortgage payment cash flow presented the opportunity to provide liquidity via a secondary market for mortgage loans, thereby increasing the availability of investment capital for housing finance.

Throughout the 1980s securitization grew in popularity to become a widely recognized, cost effective financing alternative to traditional bank sources for a large number of thrifts and other mortgage lenders. By the mid-80s securitization was extended to forms of cash flow besides first mortgage payments to include automobile loans, credit-card receivables, second mortgages, and home-equity loans. Concomitantly, parties seeking the liquidity provided by securitizing cash flows extended beyond traditional banking and other mortgage lending institutions to credit card companies and automobile finance companies. This expansion of securitization activities continued into the 1990s when securitization was extended to “residuals” such as lease-rental payments, trade receivables, and healthcare provider receivables. Securitization techniques have grown to encompass even more exotic assets like royalty fees from David Bowie's album sales, CK® perfume licensing fees, jewelry receivables, aircraft loans, health club membership fees, and even lottery winnings payment streams, along with franchise fees.
¹Economic inflation at the time resulted in severe disintermediation, a phenomenon where free market interest rates exceed the regulated interest rate ceiling for time deposits, thereby causing depositors to withdraw funds and seek higher interests rates elsewhere.

Inventive activity inspired by increasing interest in liquidity through securitization has resulted in a number of patents in this area of business method technology directed to securitizing various forms of cash flow. Examples include: U.S. Pat. No. 6,615,187 to Ashenmil et al., securitizing real estate brokerage commissions; U.S. Pat. No. 5,704,044 to Tartar et al., securitizing healthcare accounts receivable; U.S. Pat. No. 6,154,730 to Adams et al., securitizing sporting events gates receipts; and U.S. Pat. No. 5,280,426 to Edmonds, securitizing pooled winnings from games of chance.

The process of securitization underlying these business method inventions is relatively simple. First, an entity (the originator) desiring financing identifies a payment stream comprising a predictable cash flow as an asset suitable for securitization. Second, a special legal entity or Special Purpose Vehicle (“SPV”) is created to which the originator sells the assets. This effectively separates the risk related to the original entity's operations from the risk associated with collection. When done properly the loans owned by the SPV are beyond the reach of creditors in the case of bankruptcy or other financial crisis of the originator; i.e. the SPV is bankruptcy remote.

Next, to raise funds to purchase these assets the SPV issues asset-backed securities to investors in the capital markets in a private placement or pursuant to a public offering. These securities are structured to provide maximum protection from anticipated losses using credit enhancements such as letters of credit, internal credit support, reserve accounts and the like. The securities are also reviewed by credit rating agencies that conduct extensive analyses of risk in the form of bad-debts experiences, cash flow certainties, and rates of default. Based upon such analyses, the agencies then rate the securities as a risk-discounted net present value, enabling their sale, usually in the form of mid-term notes with a typical term of three to ten years.

Finally, because the underlying assets are streams of future income, a Pooling and Servicing Agreement establishes a servicing agent on behalf of the security holders. The services generally include: mailing monthly statements, collecting payments and remitting them to the investors, investor reporting, accounting, collecting on delinquent accounts, and conducting repossession and/or foreclosure proceedings as appropriate for the subject matter of the securitization. The originator, for a fee, typically services its own accounts because it already has the structures in place to do so.

Securitization has numerous advantages. Its principal advantage is in transforming relatively illiquid assets into liquid ones. In addition, as noted above, securitization insulates the holder of the securitized asset from the creditors and possible bankruptcy of the originator. Further, it is a means for an entity to access future incomes while transferring non-collection risk to others. It allows entities to raise money in capital markets at interest rates comparable to, or lower than, other generally available sources of funds. The limited-recourse nature of this financing is preferable to debt financing, which can involve personal guarantees of a borrower's principals. Securitized monies are not treated as debt so it is off-balance sheet financing. This can favorably affect leverage and the debt to equity balance sheet ratio. Finally, securitization diversifies financing sources and allows companies to plan long-term projects and investments.

In the franchise business industry, as in other industries where cash flow may be securitized, the liquidity afforded to the originator by securitization may be reinvested in the business. The functional relationships of the elements of a franchise business, however, distinguish the franchise business industry from other industries. The franchiser has a much closer relationship with and control over the source of its cash flow, the franchisee, than do originators of securitization arrangements in other forms of business. This heretofore unappreciated distinction, combined with securitization practice, enables a novel business method technology directed to maximizing return in the franchise industry.

### BRIEF DESCRIPTION OF THE INVENTION

The present invention is a system and method for maximizing the return on securitized franchise fee cash flow to a franchisor. The franchisor identifies a cash flow from a plurality of franchisees as an asset for securitization. Next, the franchiser transfers the cash flow to a Special Purpose Vehicle (SPV). The consideration the franchisor is to receive for the transfer is computed as the net present value of the cash flow, discounted by administrative fees and risk. Risk is computed based upon an analysis of bad-debts experiences, cash flow certainties, and rates of default. The risk analysis is used to rate bonds backed by the franchise fee cash flow asset, which the SPV sells to investors to obtain the funds to pay the franchisor. Advantageously, in the present invention the franchiser utilizes the liquidity obtained by securitization to identify actual risks of bad-debt and default among the plurality of franchisees. Further, the franchiser employs its special expertise in the franchise business to target investment of its securitized liquidity to mitigate such identified actual risks, thereby enhancing the actual cash flow obtained over time greatly to exceed the computed risk-discounted net present value of the asset. Yet further, by practicing the present invention, the franchisor may maximize the value of franchise cash flow by front-end loading risk mitigation efforts.

### BRIEF DESCRIPTION OF THE DRAWINGS

Other objects, advantages, features and characteristics of the present invention, as well as methods, operation and function of related elements of structure, and the combination of parts and economies of deployment, will become apparent upon consideration of the following description and claims with reference to the accompanying drawings, all of which form a part of this specification, wherein:

FIG. 1 is a flow chart for the securitization of franchise fee cash flow according to the present invention;

FIG. 2 is a mathematical formula for calculation of the net present value of a cash flow stream;

FIG. 3 is a mathematical formula showing risk discounted net present value;

FIG. 4 is a diagram of a process for maximizing the return on securitized franchise fee cash flow according to the present invention; and

FIG. 5 is a flow chart for the process of creating a data model for franchisee default and applying such model to identify at-risk franchisees according to the present invention.

### DETAILED DESCRIPTION OF THE PREFERRED EMBODIMENTS

The present invention is a system and method for maximizing the return on securitized franchise fee cash flow to a franchisor. The benefits conferred by this invention are best appreciated beginning with an understanding of the securitization process.

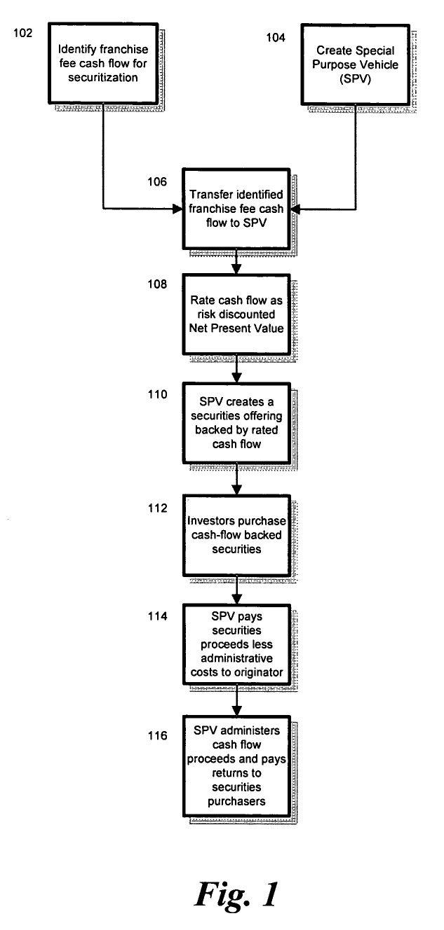

Turning to FIG. 1, securitization of a franchise fee cash flow stream begins with the identification 102 of a source of franchise fees that is suitable for securitization. Generally speaking, a cash flow source is suitable for securitization if it is relatively predictable over time. As will be discussed in greater detail below in reference to FIG. 3 and risk discounts applicable to cash flow assets, as the predictability of a cash flow stream increases, the risk associated with the cash flow stream diminishes, thereby enhancing the value of the cash flow stream as an asset for securitization. A suitable franchise fee cash flow stream will generally comprise franchise fee payments from a plurality of franchisees who have a historically supported payment history.

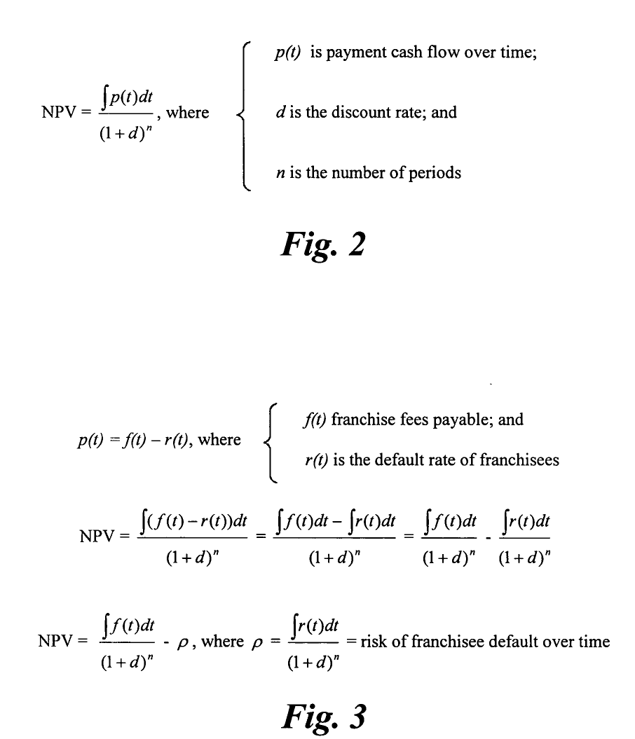

To securitize the identified franchise fee cash flow, a Special Purpose Vehicle (SPV) is created 104 to manage the securitization process. The owner of the franchise fee cash flow (the “originator”) transfers its ownership in the cash flow 106 to the SPV. The cash flow asset, now owned by the SPV, is then rated 108 to determine a risk discounted net present value of the asset, as discussed in more detail in reference to FIG. 2 below. Based upon the rating of the cash flow, the SPV then supports a securities offering with the rated cash flow and offers securities 110 in the form of bonds or similar instruments, which are then purchased 112 by investors.

The SPV pays the proceeds from the sale of the securities, less an administrative fee, to the originator 114 as consideration for the transfer 106 of the cash flow from the originator to the SPV. The SPV then proceeds to manage the franchise fee cash flow and pay returns to investors 116.

FIG. 2 presents a mathematical formula for determining the net present value (NPV) of a cash flow stream. Cash flow itself is a function of time. It may be viewed as the time rate of exchange of cash, p(t), from a payment source to a payee. In the case of franchise fees, cash flow is the payment stream from the franchisees to the franchisor. The net present value of a cash flow over an interval of time comprising n periods is the summation of cash flow over the interval, indicated in FIG. 2 as the integral of the payment cash flow function p(t) over the interval, discounted to present value based upon the discount rate d applicable to the periodicity of n in the interval.

By way of example, let us suppose that a franchisor has three franchisees, A, B, and C, from whom franchise fees are due as follows:
A pays $10,000 annually;
B pays $5,000 annually; and
C pays $2,500 annually.

Assuming A, B, and C always pay their franchise fees, the cash flow for the three franchisees is $17,500 per year. Over five years, the franchisor would expect to receive (5×$17,500) or $87,500. Because of the time value of money, however, the net present value of that income stream is less than the total sum that the franchisor will receive over time. The time value of money is reflected in a discount rate. The applicable discount rate for the owner of a cash flow asset is the interest rate that the owner could obtain for present investment of cash. Let us assume for the sake of this example that the applicable discount rate is 3% annually. Based upon that assumption, the net present value of the income stream that the franchiser expects from A, B, and C over five years is $87,500 divided by 1.03 to the fifth power, or $75,478.27.

The assumption that franchisees always pay their fees, however, is not consistent with actual franchise experience. With any suitably large plurality of franchisees, there is a risk over time that some percentage of the franchisees will partially or entirely default on their franchise fee payments. Turning to FIG. 3, we see that franchise fee cash flow, p(t) may be represented as the difference between the franchise fee rate, f(t), and the default rate, r(t). The net present value of the cash flow, then, is the difference between the overall franchise fee rate over time and the default rate over time. This latter value, the default rate over time (represented by the Greek letter rho in FIG. 3), is the risk discount of the securitized franchise fee cash flow. In the process of rating the actual present value of a cash flow to be securitized, credit rating agencies make an estimate of the risk discount applicable to the future cash flow. This estimate is based principally upon an analysis of historical data most closely matching the parameters of the cash flow to be securitized. However, by reducing the default rate below that which is indicated by historical behavior, the cash flow exceeds the estimated value, and thereby the actual value of the franchise fee cash flow is increased. Put differently, if more franchisees are prevented from defaulting than the historical data would indicate, the actual sum accrued from franchise fees over time will be greater than the estimate by the credit rating agencies upon which the securities offering was based.

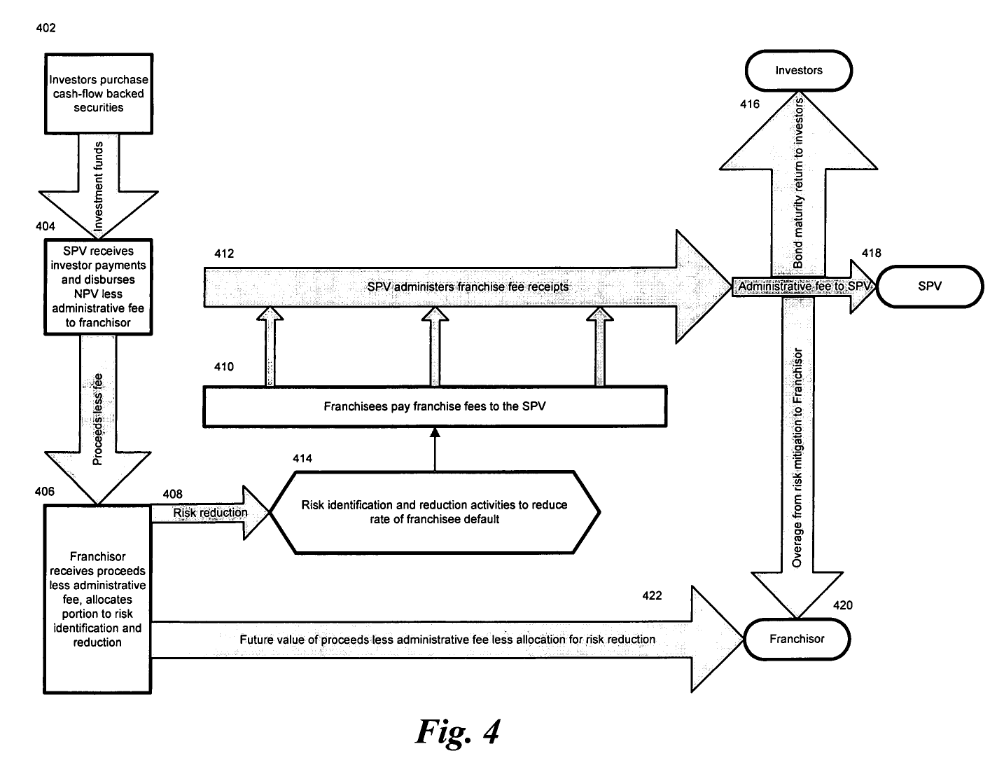

Turning now to FIG. 4, depicted is a process according to an embodiment of the present invention. The purchase 402 of cash-flow backed securities by investors (112 in FIG. 1) results in investment funds which are received 404 by the SPV. A majority of the funds, representing the net present value of the securitized cash flow less an amount retained to cover the administrative expenses of the SPV, are then disbursed 406 to the franchisor. Advantageously, the franchisor allocates 408 a portion of the funds it has received for risk identification and reduction activities, described in greater detail below.

During the period in which the cash flow is securitized, franchise fees are paid 410 by franchisees to the SPV, which accumulates and administers 412 franchise fee receipts. In accordance with the teaching of the present invention, during that period the franchisor utilizes the portion of funds that have been specially allocated 408 to fund targeted risk identification and reduction activities 414 to reduce the rate of franchisee default.

At the conclusion of the securitization period, the SPV pays the maturity value of the investment bonds 416 to the investors. After deduction 418 for its administrative expenses, the SPV pays any remainder of franchise fee accumulations to the franchisor 420. Significantly, at the end of the securitization period, the total value of the funds received by the franchisor according to this process will be the sum of the following two amounts: the future value 422 of the difference between the proceeds the franchisor is to receive 406 from the securitization of the cash flow and the amount allocated 408 for risk reduction; and the overage 420 received from the SPV resulting from risk mitigation efforts. Advantageously, by capitalizing upon the expertise of the franchisor and the special relation between the franchisor and its franchisees, the funded, targeted risk identification and mitigation taught by the present invention enables that sum realized by the franchisor at the end of the securitization period to be greater than the accumulation of franchise fees without the benefit of this technology.

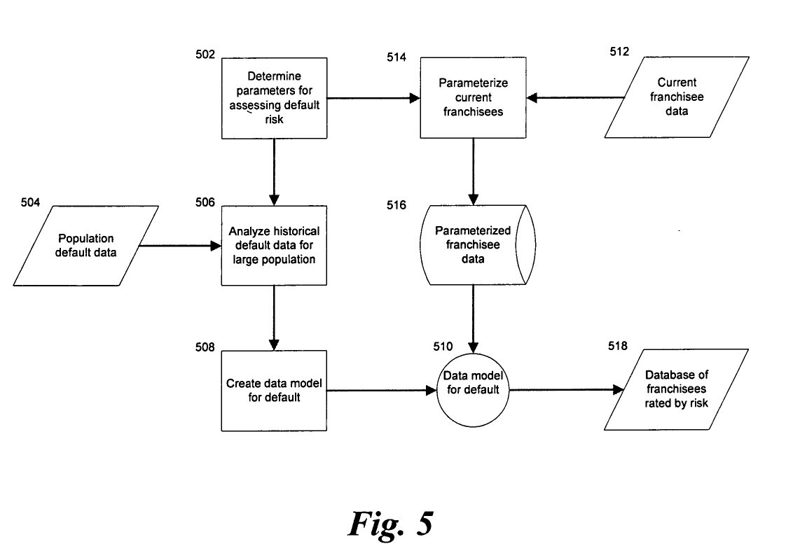

Data modeling may be used to identify franchisees at risk of default. Turning to FIG. 5, illustrated is a population history data modeling method for such identification. The factors contributing to franchisee default, as well as the relative weight of each such factor, vary depending upon the nature of the franchise business. An analysis of the relative risk contribution of the various risk factors applicable to a particular franchise business requires an examination of business performance along a number of parameters. Such parameters are identified 502 by the franchisor based upon its expert knowledge of the business, and may include:

(1) Historical performance (if applicable)

(2) Location of asset (e.g. airport, highway, urban, rural, etc.)

(3) Quality of asset (e.g. age, capital improvements, etc.)

(4) Management—number of years of relevant experience

(5) Management—number of years of general entrepreneurial experience

(6) Competition—direct and indirect

(7) Quality of employees (e.g. number of years at company, salary)

(8) Current legislation affecting growth/business use

(9) Third party versus direct management

(10) Invested equity (typically, in a small business enterprise, those individuals who invest more equity into a project are at more risk and are thus incentivised to perform)

Other parameters, some of which are highly specific to a particular franchise business, may be employed by the franchisor for its risk analysis. In any case, based upon its specific knowledge of the particular franchise business, the franchisor determines parameters for assessing default risk.

In the depicted embodiment, using historical data 504 for a representative population of franchisees (such as that employed by the credit rating agency in the rating process described earlier), in combination with its specific knowledge of the franchise business, the franchisor analyses the data 506, to create a historical data model 508, 510 such as a histogram for franchisee failure, along the parameters previously identified 502. Data model 510 thereby allows analysis of risk, based upon historical experience in relation to the identified risk parameters. Data 512 on franchisees in the franchise business for which securitization has been obtained may be categorized 514, 516 according to the identified risk parameters. By applying the historical risk experience data model 510 to the categorization applicable to the franchisees 516, the franchisor may then determine the level of relative risk of default of each of its franchisees 518;

Depending upon the nature and quality of historical population data on franchisee default 504 as well as the parameters selected for assessing default risk 502, creating the data model for default of franchisees 508 may require considerable resources. Incomplete or unreliable historical data will require the application of tools such as regression analysis to arrive at relatively accurate estimates for probabilities of franchisee default. Further, the parameters selected may not be independent in their effect on franchisee default, but rather may interact in various and complex ways, requiring sophisticated multivariate analytical techniques to create a reliable data model for franchisee default.

As will be appreciated by those of skill in the art of data modeling, other methodologies that are not historically derived may also be advantageously employed to identify franchisees at risk for default. For example, a data model based upon a correct predictive hypothesis may be constructed without reference to historical data. The present invention is not limited to any particular data modeling process. Rather, embodiments of the present invention may utilize any data modeling methodology, or any combination of methodologies, effective in identifying at risk franchisees. In any case, the present invention utilizes the capital made available to the franchisor by securitizing franchise fee cash flow to provide the resources necessary to create useful data models for predicting franchisee default and to apply those models to the franchisees contributing to that cash flow in order to identify risk.

Having identified at-risk franchisees, the franchisor is thereby able to engage in efforts targeted at such franchisees to reduce the risk of default. In the present invention, the franchisor utilizes the capital made available by securitization of franchise cash flow to fund risk mitigation measures. The risk mitigation measures available to the franchisor may be categorized as principally directed to increasing the franchisee's business volume, to enhancing franchisee human capital, or to increasing the franchisee's business operational efficiency, with some measures falling in more than one category.

In the first category, franchisor-supported improved marketing and advertising of the franchisee's business may have a beneficial effect upon those franchisee businesses that have been operating below capacity. In the same category are those physical improvements to the franchisee establishment, funded by the franchisor, that have the effect of attracting more customers for the franchisee. Further, the franchisor may implement and fund measures within the franchise operation itself directed to mitigating risk of franchisee default. Such measures may include national or regional advertising and marketing by the franchisor of the franchise business generally, designed and targeted specifically to increase business for at-risk franchisees. Further, the franchisor may introduce and market new franchised products or services specifically targeted to improve customer traffic for at-risk franchisees. These and other measures well known to those in the marketing and advertising arts, funded at least in part by capital made available from securitized franchise cash flow as taught by the present invention, may be effectively employed by the franchisor to reduce the incidence of franchisee default.

Other risk mitigation measures are directed more to improving individual and group performance of franchisee management and staff. Included in such measures to enhance franchisee human capital are training of current franchisee management and staff and recruiting experienced personnel for employment by the franchisee. Additionally, risk mitigation measures may be directed toward retention of skilled franchisee employees, as by enhancing employee benefits or by aligning employee working hours to optimize employee work/life balance. As is well known to those of skill in the art of human resource management, the franchisor may fund these and many other means of improving individual and group performance by franchisee management and staff, enhancing franchisee human capital and thereby reducing the risk of franchisee default.

Yet other risk mitigation measures may be directed toward improving and modernizing franchisee business processes, as by providing expert business and management consulting services to the franchisee. Franchisor funded technology in the form of computer software solutions (such as Smarter Hospitality by Microsoft Corporation for the hospitality industry or enhanced point-of-sale software by VersiTouch, Inc. of Portland, Oreg. for the restaurant industry) may also be adopted with beneficial effect. The franchisor may utilize the finding obtained from securitization to employ these and any number of other means well known to those of ordinary skill in the area of operations research, management science and related arts, to improve the operational effectiveness of the franchisee's business and thereby reduce the risk of franchisee default.

Utilizing a portion of the funds made available by securitization, the franchisor may fund risk mitigation efforts as business expenses, as set forth above. In the alternative, the franchisor may direct such funds to equity investment in the franchisee business, such investment targeted to reduce risk of franchisee default. For example, by purchasing an equity interest in real property associated with the franchisee business, the franchisor may make improvements to the property that have the effect of attracting more customers. Advantageously, the franchisor may obtain conventional financing for such improvements secured by its real estate interest. Further, the franchisor may acquire an interest in tangible business assets of the franchisee operation, by purchasing such an interest from the franchisee, thereby providing liquidity to the franchisee for it to engage in risk mitigation efforts, or by contributing additional tangible business assets to the franchisee operation, such assets selected to increase the business volume of the franchisee or to improving its business processes. As will be clear to those of skill in the art, the franchisor may engage in a wide variety of risk mitigation measures by targeted equity investment. In any case, in embodiments of the present invention in which the franchisor directs a portion of the liquidity afforded by securitization to risk mitigation targeted equity investment, the franchisor not only receives the benefit of increased realized cash flow receipts resulting from risk reduction, as set forth in the foregoing, but also may realize the additional benefits of equity participation, such as appreciation in value of equity assets and the availability of financing secured by such assets.

Turning now to the timing of risk identification and mitigation efforts, in preferred embodiments of the present invention, the franchisor will concentrate such efforts earlier in the securitization period rather than later. Such practice is preferred for two principal reasons. First, an at-risk franchisee is not only at higher risk of default in payment of franchise fees, but it also is at a higher risk of failure altogether. If a franchisee's operation fails altogether, its contribution to cash flow is lost from the point of failure forward. The earlier a franchisee operation fails in the securitization period, the greater the sum of money lost in total receipts, assuming the failed operation is not somehow replaced. A second reason that earlier risk mitigation is preferred is simply a result of the time value of money. Referring back to FIG. 3, it will be clear to those of skill in the actuarial arts that defaults occurring earlier in the securitization period have a more significant effect on the overall risk discount, rho, than defaults occurring later in the period.

### CONCLUSIONS, RAMIFICATIONS AND SCOPE

Accordingly, it can be seen that the invention described herein utilizes liquidity obtained through securitization to identify cash flow risks and advantageously to exploit the distinctive aspects of the franchise business to mitigate such risks. The result is that the actual franchise fee cash flow obtained by the franchisee will exceed the computed risk-discounted cash flow that is securitized.

Although the detailed descriptions above contain many specifics, these should not be construed as limiting the scope of the invention but as merely providing illustrations of some of the presently preferred embodiments of this invention. Various other embodiments and ramifications are possible within its scope, a number of which are discussed in general terms above. It is intended that the scope of the present invention encompass all means known to those of skill in the art for utilizing securitized franchise fee cash flow to enhance franchise business performance according to its teachings.

While the invention has been described with a certain degree of particularity, it should be recognized that elements thereof may be altered by persons skilled in the art without departing from the spirit and scope of the invention. Accordingly, the present invention is not intended to be limited to the specific forms set forth herein, but on the contrary, it is intended to cover such alternatives, modifications and equivalents as can be reasonably included within the scope of the invention. The invention is limited only by the following claims and their equivalents.

I claim:

1. A method of enhancing cash flow receipts in a franchise operation, comprising securitizing cash flow from an identified plurality of franchisees to obtain capital;
identifying franchisees at risk of default among the plurality of franchisees, such identification funded by a first portion of the capital obtained from securitization; and
mitigating risk of default of the identified franchisees, such mitigation funded by a second portion of the capital obtained from securitization.

2. A method of enhancing cash flow receipts according to claim 1, wherein the step of securitizing comprises:
rating at least one offering of securities based upon franchise fee receipts from the identified plurality of franchisees; and
selling the rated securities.

3. A method of enhancing cash flow receipts according to claim 1, wherein the step of securitizing comprises:
creating a Special Purpose Vehicle to manage the securitization process;
rating at least one offering of securities based upon franchise fee receipts from the identified plurality of franchisees;
creating a pooling agreement to direct franchise fee receipts for a designated period from the identified plurality of franchisees to the Special Purpose Vehicle and
selling the rated securities by the Special Purpose Vehicle.

4. A method of enhancing cash flow receipts according to claim 1, wherein the step of identifying franchisees at risk of default comprises creating a predictive risk experience data model and applying the risk experience data model to the plurality of franchisees.

5. A method of enhancing cash flow receipts according to claim 4, wherein the step of creating a predictive risk experience data model comprises analyzing historical data of default in a population of franchisees.

6. A method of enhancing cash flow receipts according to claim 4, further comprising the step of identifying at least one parameter associated with risk of default, and the predictive risk experience data model is created and applied based upon the at least one parameter.

7. A method of enhancing cash flow receipts according to claim 1, wherein the risk mitigation step is comprised at least in part of investment of the second portion of the capital obtained from securitization in equity.

8. A method of enhancing cash flow receipts according to claim 7, wherein the equity investment is in real estate.

9. A method of enhancing cash flow receipts according to claim 7, wherein the equity investment is in tangible business property.

10. A method of enhancing cash flow receipts in a franchise operation, comprising
identifying a plurality of franchisees forming a group suitable for securitization;
securitizing cash flow from the identified group for a designated period to obtain capital;
identifying franchisees at risk of default among the group, such identification funded by a first portion of the capital obtained from securitization; and
mitigating risk of default of the identified franchisees, such mitigation funded by a second portion of the capital obtained from securitization.

11. A method of enhancing cash flow receipts according to claim 10, wherein the steps of identifying franchisees at risk and mitigating risk of default are substantially performed in the first half of the designated period.
